(19) United States
(12) Patent Application Publication
(10) Pub. No.: US 2010/0043986 A1
(43) Pub. Date: Feb. 25, 2010

(54) NET LEAF

(76) Inventor: Chin Tiao Huang, Tainan City (TW)

Correspondence Address: SINORICA, LLC, 2275 Research Blvd., Suite 500, ROCKVILLE, MD, 20850, US

(21) Appl. No.: 12/195,458

(22) Filed: Aug. 21, 2008

(51) Int. Cl. E06B 3/80

(52) U.S. Cl. 160/327; 181/141

(57) ABSTRACT

A net leaf is composed of a main body and a terminal unit. The main body is a thin flat piece. The terminal includes a first terminal and a second terminal, which are respectively inclined upward and downward at two ends of the main body. By means of nanotech, relevant thickness and length of the net leaf are so fine that the net leaf has a comparatively strong structure. And a screen made of the net leaves can prevent sunlight from directly shooting into a house, enhancing indoor privacy. Moreover, with sound deadening holes formed in the main body and the terminal unit, noise can be isolated to provide a quiet indoor environment.

### BACKGROUND OF THE INVENTION

1. Field of the Invention

This invention relates to a net leaf, particularly to one finely made by nanotech with various functions.

2. Description of the Prior Art

Commonly, a conventional screen employed to keep insects from migrating into houses is mainly provided with a net made of steel wire. However, such a net has a very straitlaced structure and works solely for one purpose. Thus, if the net can be structurally improved by nanotech, it can be precisely and finely manufactured so as to achieve other advantageous functions than isolating insects. Moreover, it is to conform to a contemporary trend of green construction material and saving energy, giving people more benefits in living.

The disadvantages of the conventional screen are described below.

1. The net of the conventional screen is formed with such a straitlaced structure that it is difficult to be technically improved to substantially provide industrial value.

2. As the conventional screen is nothing but a means to isolate insects, it cannot function further to bring people more advantages.

### SUMMARY OF THE INVENTION

The object of this invention is to offer a net leaf finely made by nanotech with diverse functions.

The main characteristics of the invention are a main body and a terminal unit. The main body is a thin flat piece. The terminal includes a first terminal and a second terminal, which are respectively inclined upward and downward at two ends of the main body. A plurality of sound deadening holes is formed in the main body and the terminal unit. By means of nanotech, relevant thickness and lengths of the net leaf are so fine that the net leaf has a comparatively strong structure. A screen made of the net leaves obliquely strung together can not only prevent insects from migrating into a house, but also prevent sunlight from directly shooting into a house, enhancing indoor privacy and reduce noise.

### BRIEF DESCRIPTION OF DRAWINGS

This invention is better understood by referring to the accompanying drawings, wherein:

FIG. 1 is a perspective view of a preferred embodiment of a net leaf in the present invention;

FIG. 2 is a cross-sectional view of a “A-A” line in FIG. 1, showing the structure of sound deadening holes;

FIG. 3 is a perspective view of the net leaves fixedly strung together by a fine line; and

FIG. 4 is schematic view of a screen made of the net leaves strung together.

### DETAILED DESCRIPTION OF THE PREFERRED EMBODIMENT

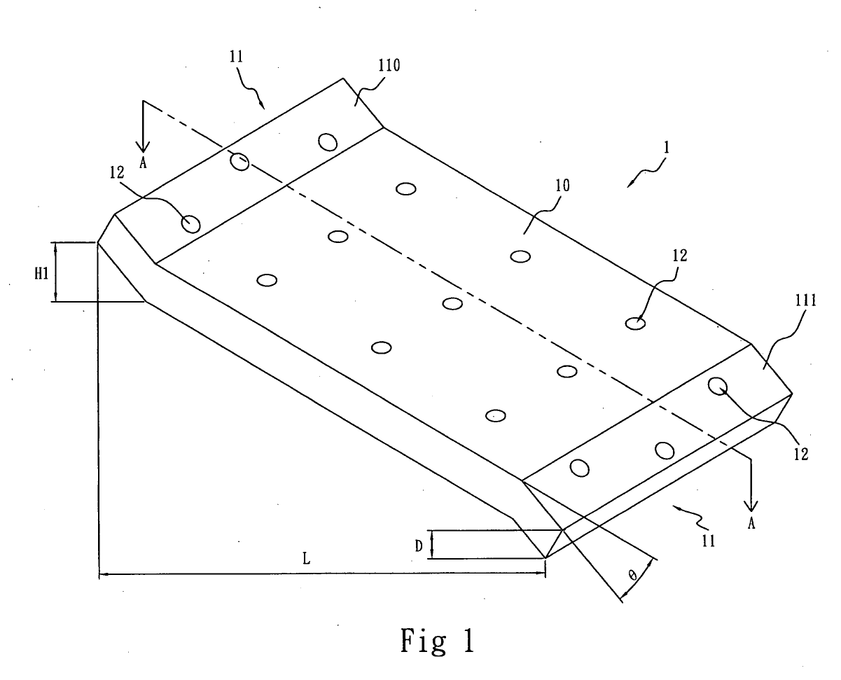

As shown in FIG. 1, a preferred embodiment of a net leaf 1 in the present invention is composed of a main body 10 and a terminal unit 11.

The main body 10 is formed as a thin flat piece.

The terminal unit 11 is provided with a first terminal 110 and a second terminal 111, which are respectively formed at two ends of the main body, inclined upward and downward with the extension of the main body 10 by a curved angle θ. The curved angle θ is designed between 25˜30 degrees, and 28 degrees is preferable. Of course, the first terminal 110 and the second terminal 111 can be respectively inclined either upward and downward or downward and upward.

With the net leaf 1 manufactured by means of nanotech, a length (L) measured from the first terminal 110 to the second terminal 111 is proposed between 0.9 mm and 1.1 mm, and 1 mm is preferable. A vertical height (H1) measured from the first terminal 110 or the second terminal 111 to the main body 10 is designed from 0.09 mm to 0.12 mm, and 0.1 mm is preferred. A thickness (D) of the main body 10 and the terminal unit 11 ranges from 0.09 mm to 0.12 mm, and 0.1 mm is preferred.

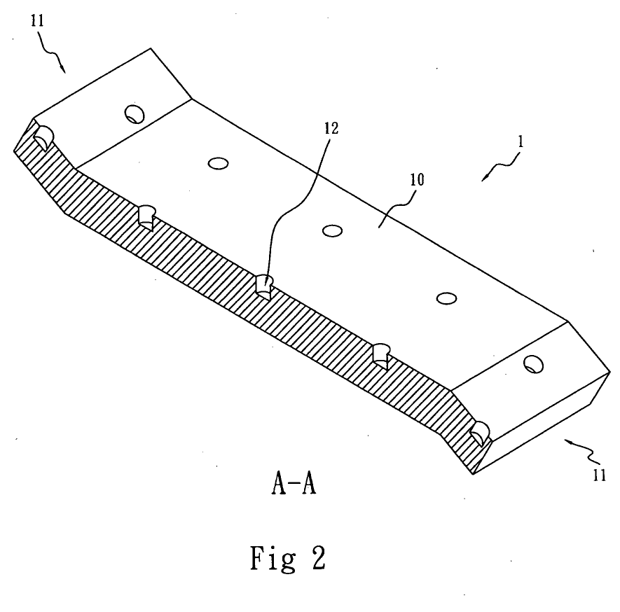

In addition, as shown in FIG. 2, which is a cross-sectional view of the “A-A” line in FIG. 1, a plurality of sound deadening holes 12 are formed spaced apart properly in the surface of the main body 10 and the terminal unit 11. Therefore, after sound enters the sound deadening holes 12 it may cause friction between the inner wall of the main body 10 and the terminal unit 11 so as to keep sound energy faded out. Thus, noise surrounding a house can be opportunely absorbed so that a quiet indoor environment can be obtained. The sound deadening holes 12 can be communicated with one another among the main body 10 and the terminal unit 11 if necessary.

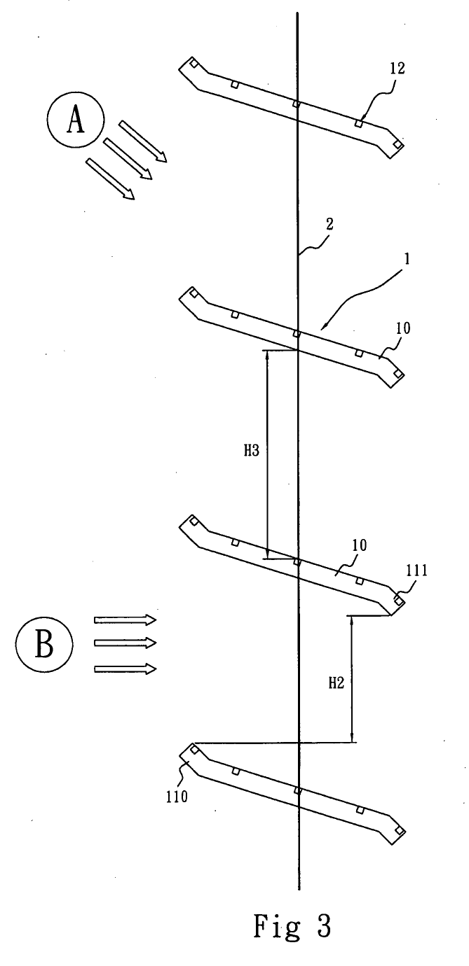

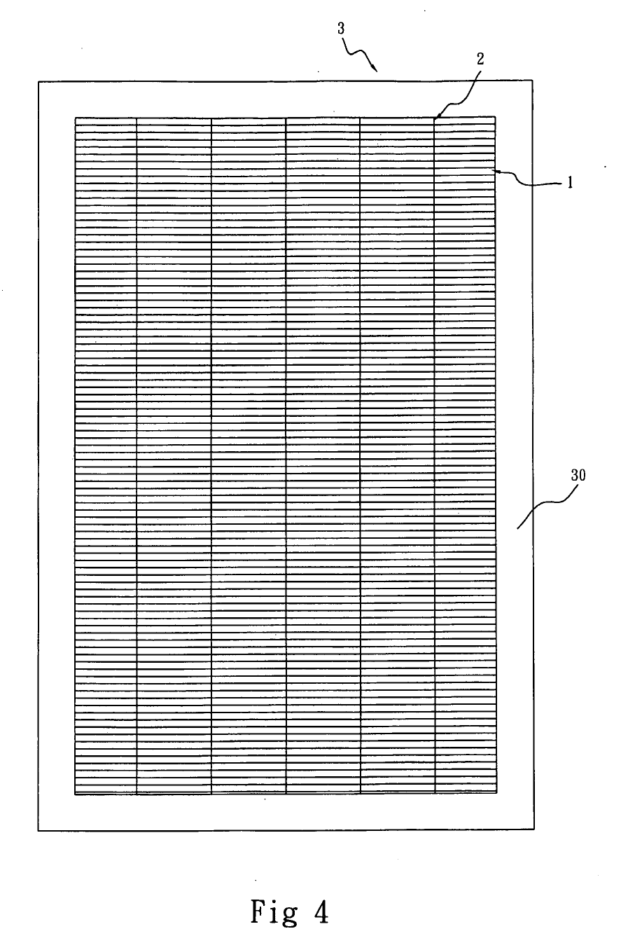

Further, FIG. 3 shows how the net leaves 1 are connected together, and FIG. 4 shows a structure of a screen made of the net leaves 1.

As the main body 10 has a thickness (D) as thin as 0.09 mm˜0.12 mm, a fine line made via nanotech can be utilized as well to fixedly string at least two net leaves 1 to become a screen 3, with each net leaf 1 arrayed with a certain oblique angle for combining with the adjacent net leaf 1. Having the net leaves 1 strung together and positioned in a sash 30, the first terminals 110 point toward the outside of a house and the second terminals 111 point toward the inside of a house. The second terminal 111 of each net leaf 1 is spaced apart from the first terminal 110 of the neighbor net leaf 1 by a vertical distance (H2) ranging from 0.45 mm to 0.55 mm, and 0.5 mm is preferable. In addition, every two adjacent net leaves 1 are separated apart with a vertical distance (H3) ranging from 0.9 mm to 1.1 mm, and 1 mm is preferred.

As mentioned previously, the sound deadening holes 12 formed in the surface of the main body 10 and the terminal unit 11 can keep sound faded out through friction between the inner wall of the main body 10 and the terminal unit 11, so that a quiet indoor environment can be maintained. With the net leaves 1 closely strung and obliquely arrayed to become the screen 3, sunlight shining in an inclined angle as shown in the “A” region of FIG. 3 cannot directly shoot into a house owing to the designed curve of the first terminal 110 facing outward a house and the second terminal 111 facing inward a house, and only sunlight shining horizontally as shown in the “B” region of FIG. 3 can shoot into a house because the distance (H2) existing between the second terminal 111 of each net leaf 1 and the first terminal 110 of an adjacent net leaf 1 is strictly set between 0.45 mm and 0.55 mm (0.5 mm is preferred). By that, sunlight shooting into a house can be lessened to keep indoor temperature lowered so as to save energy. Moreover, with the first terminal 110 curved, a person is unable to directly see into a house through the screen 3 but able to see through outward from inside a house, advancing indoor privacy. And, as the net leaf 1 is made via nanotech and the distance (H3) between two adjacent net leaves 1 strung is as small as 0.9 mm˜1.1 mm (1 mm is preferred), not only insects or even dust can be prevented from passing through the screen 3 made of the net leaves 1 but also the screen 3 is more finely and firmly formed if compared to a conventional screen.

The invention has the following advantages as can be seen from the foresaid description.

1. With the sound deadening holes 12 formed in the main body 10 and the terminal unit 11, noise can be absorbed by the net leaf 1 to maintain a quiet indoor environment.

2. With the net leaves 1 closely strung and obliquely arrayed, and the first terminal 110 and the second terminal 111 curved, sunlight shining in inclined angles cannot directly shoot into the inside of a house so that indoor temperature can be relatively lowered to save energy needed for air cooling or ventilation.

3. Through the screen 3 made of the net leaves 1, a person is unable to directly see inward a house from the exterior, but able to see outward inside a house, enabling indoor privacy enhanced.

4. As the distance (H3) between two adjacent net leaves 1 strung is quite small, not only insects can be prevented from migrating into a house but also dust can be more or less isolated outside a house.

5. Because the net leaves 1 are made via nanotech, the screen 3 made of the net leaves 1 is finer and firmer than a conventional screen is.

While the preferred embodiment of the invention has been described above, it will be recognized and understood that various modifications may be made therein and the appended claims are intended to cover all such modifications that may fall within the spirit and scope of the invention.

What is claimed is:

1. A net leaf comprising:
a main body formed as a thin flat piece; and
a terminal unit provided with a first terminal and a second terminal respectively formed at two ends of said main body, said first terminal and said second terminal inclined upward and downward with an extension of said main body in a curved angle so that a vertical height is formed between a free end of said terminal unit and said main body.

2. The net leaf as claimed in claim 1, wherein a length measured from said first terminal to said second terminal ranges from 0.9 mm to 1.1 mm.

3. The net leaf as claimed in claim 1, wherein a vertical height measured from said first terminal or said second terminal to said main body is designed from 0.09 mm to 0.12 mm.

4. The net leaf as claimed in claim 1, wherein a thickness of said main body and said terminal unit ranges from 0.09 mm to 0.12 mm.

5. The net leaf as claimed in claim 1, wherein said curved angle inclined between said terminal unit and said main body is between 25˜30 degrees.

6. The net leaf as claimed in claim 1, wherein said first terminal and said second terminal are respectively inclined either upward and downward or downward and upward.

7. The net leaf as claimed in claim 1, wherein said main body is provided with plural sound deadening holes properly spaced apart.

8. The net leaf as claimed in claim 1, wherein said terminal unit is provided with plural sound deadening holes properly spaced apart.

9. The net leaf as claimed in claim 1, wherein a fine line is employed to fixedly string at least two said net leaves that are obliquely arrayed with a certain inclined angle.

10. The net leaf as claimed in claim 9, wherein said second terminal of each net leaf is spaced apart from said first terminal of a neighboring net leaf by a vertical distance ranging from 0.45 mm to 0.55 mm.

11. The net leaf as claimed in claim 9, wherein every two adjacent net leaves are separated apart with a gap ranging from 0.9 mm to 1.1 mm.
